(19) United States
(12) Patent Application Publication
(10) Pub. No.: US 2013/0185808 A1
(43) Pub. Date: Jul. 18, 2013

(54) APPARATUS AND METHOD FOR PROTECTING DATA STORED IN DATA STORAGE DEVICE

(71) Applicant: ZHONG-LIN XU, Shenzhen City (CN)

(72) Inventor: ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/517,708

(22) Filed: Jun. 14, 2012

(30) Foreign Application Priority Data
Jan. 12, 2012 (CN) 201210008335.9

(51) Int. Cl. G06F 21/24

(52) U.S. Cl. 726/28; 726/26

(57) ABSTRACT

A computerized method protects data stored in a data storage device. One or more safe destinations are set and correlated with predetermined data of the data storage device. When target data correlated with the safe destinations is needed to be transmitted to a target destination, whether the target destination matches with one of the safe destinations is determined. A data transmission program of the data storage device is executed, and the target data is transmitted to the target destination using the data transmission program, when the target destination matches with one of the safe destinations. If the target destination does not match with any of the safe destinations, a user is notified to input a password and the target data is transmitted to the target destination when the user has input a valid password within a predetermined time period.

### BACKGROUND

1. Technical Field

Embodiments of the present disclosure relate generally to data security technologies, and particularly to an apparatus and a method for protecting data stored in a data storage device.

2. Description of Related Art

Data storage devices, such as mobile phones and personal digital assistants (PDA), may be used to store various data, which may include some private or confidential data. Sometimes, the data stored in the data storage devices may be illegally copied or transmitted to other devices. If private or confidential data is leaked without authorization, the owner of the data may experience difficulties or incalculable losses. Therefore, an improved solution for data security of the data storage device is desired.

### BRIEF DESCRIPTION OF THE DRAWINGS

FIG. 1 is a schematic block diagram illustrating one embodiment of a data storage device including a data protection system.

FIG. 2 shows a flowchart of one embodiment of a data protection method implemented by the data storage device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

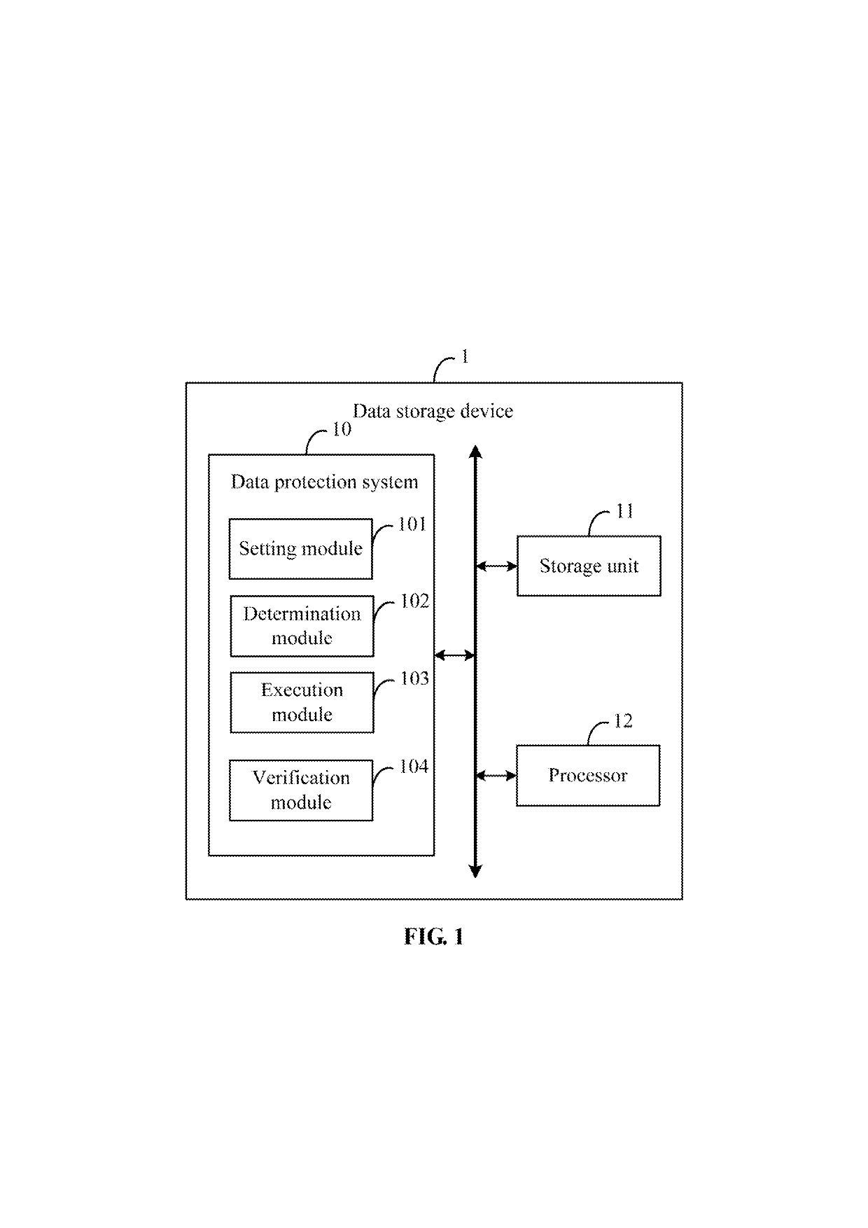

FIG. 1 is a schematic diagram illustrating one embodiment of a data storage device 1 including a data protection system 10 for protecting data in the data storage device 1. In the embodiment, the data storage device 1 further includes a storage unit 11, and a processor 12. In one embodiment, the data storage device 1 may be, for example, a mobile phone, a personal digital assistant (PDA), or other similar device. FIG. 1 is one example of the data storage device 1, the data storage device 1 can include more or fewer components than those shown in the embodiment, or have a different configuration of the components.

The data protection system 10 may include a plurality of programs in the form of one or more computerized instructions stored in the storage unit 11 and executed by the processor 12 to perform operations of the data storage device 1. In the embodiment, the data protection system 10 includes a setting module 101, a determination module 102, an execution module 103, and a verification module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The setting module 101 sets one or more safe destinations, and correlates the one or more safe destinations with predetermined data stored in the data storage device 1. In the embodiment, each of the safe destinations is defined as an objective storage medium, which is authorized by a user to receive the predetermined data transmitted from the data storage device 1. The objective storage medium may include terminal devices (e.g., mobile phones and computers), website servers having determined website addresses, and other similar storage devices. In one example, when a terminal device is set as one of the safe destinations, identification of the terminal device is stored in the storage unit 11. For example, if the terminal device is a mobile phone, the identification of the mobile phone may be international mobile equipment identification (IMEI) of the mobile phone. If the terminal device is a computer, the identification of the computer may be a MAC address of the computer. If the terminal device is a website server, identification of the website server may be a website address of the website server.

The determination module 102 determines whether a target destination matches with one of the safe destinations, when target data of the data storage device 1 correlated with the safe destinations is needed to be transmitted to the target destination.

The execution module 103 executes a data transmission program of the data storage device 1, and transmits the target data to the target destination, when the target destination matches with one of the safe destinations. For example, if the target destination is a particular website server, the execution module 103 transmits the target data to the particular website server through a network between the data storage device 1 and the particular website server. If the target destination is a terminal device, the execution module 103 transmits the target data to the terminal device using a connection medium, such as BLUETOOTH or a data transmission bus connected between the data storage device 1 and the terminal device.

Upon the condition that the target destination does not match any of the safe destinations, the verification module 104 notifies the user to input a password and verifies whether the user is authorized to transmit the target data. In detail, the verification module 104 determines whether the user has input a valid password that is the same as a preset password within a predetermined time period. If the user has input the valid password within the predetermined time period, the user of the data storage device 1 is verified to be authorized to transmit the target data, and the execution module 103 transmits the target data to the target destination using the data transmission program. If the user has not input the valid password within the predetermined time period, the user is verified not to be authorized to transmit the target data, and the execution module 103 prevents the transmission of the target data to the target destination. In the embodiment, the preset password may be preset by the user using the setting module 101. As mentioned above, even if the target destination does not match any of the safe destinations, the target data can also be transmitted to the target destination upon the condition that a valid password has been inputted.

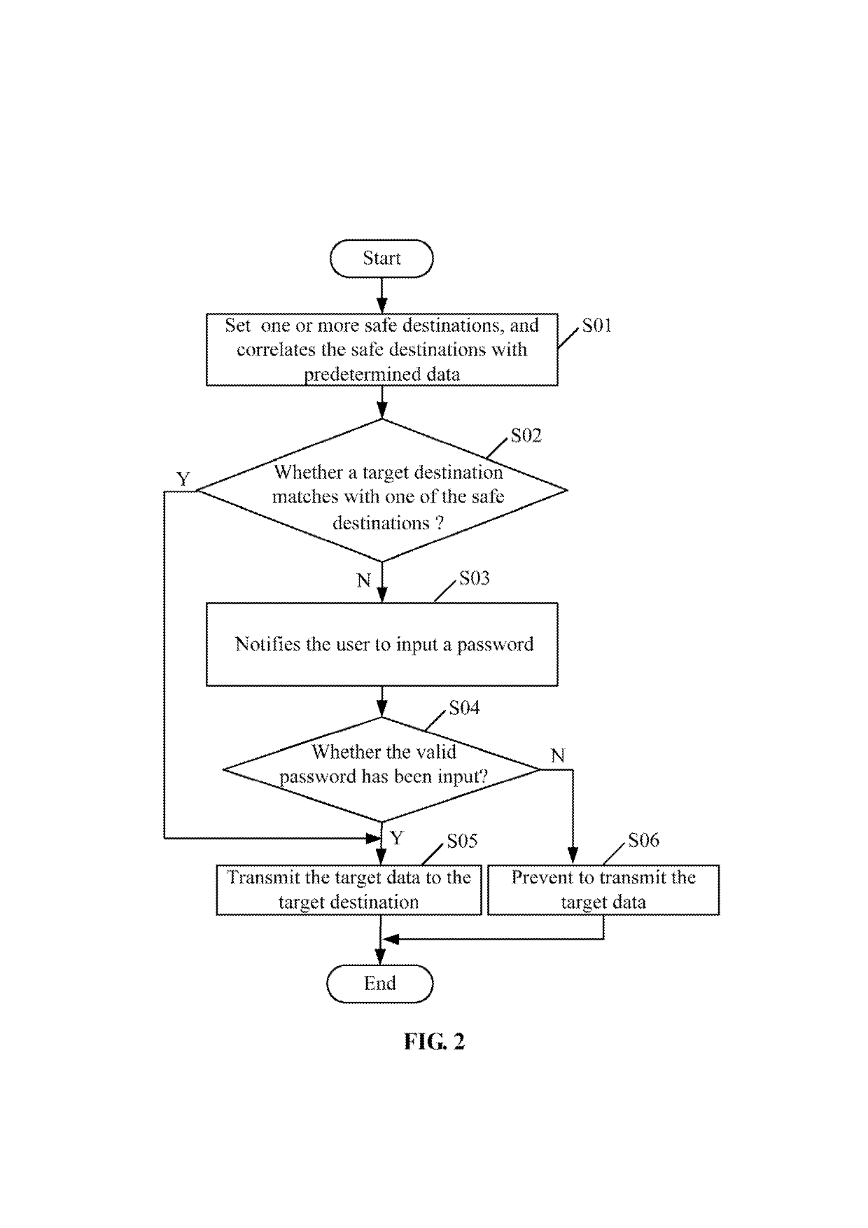

FIG. 2 shows a flowchart of one embodiment of a data protection method implemented by the data storage device 1 of FIG. 1. Depending on the embodiment, additional steps may be added, others removed, and the ordering of the steps may be changed.

In step S01, the setting module 101 sets one or more safe destinations, and correlates predetermined data of the data storage device 1 with the one or more safe destinations.

In step S02, when target data stored correlated with the safe destinations is needed to be transmitted to a target destination, the determination module 102 determines whether the target destination matches with one of the safe destinations. If the target destination matches with one of the safe destinations, step S05 is implemented.

Otherwise, if the target destination does not match with any of the safe destinations, step S03 is implemented.

In step S03, the verification module 104 notifies the user to input a password when the target destination does not match any of the safe destinations.

In step S04, the verification module 104 determines whether the user has input a valid password that is the same to a preset password within a predetermined time period. If the user has input the valid password within the predetermined time period, the user of the data storage device 1 is verified to be authorized to transmit the target data and step S05 is implemented. If the user has not input the valid password within the predetermined time period, the user of the data storage device 1 is verified not to be authorized to transmit the target data and step S06 is implemented.

In step S05, the execution module 103 executes a data transmission program of the data storage device 1, and transmits the target data to the target destination.

In step S06, the execution module 103 prevents the transmission of the target data to the target destination.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for protecting data stored in a data storage device, the method comprising:
setting one or more safe destinations, and correlating predetermined data of the data storage device with the one or more safe destinations;
determining whether a target destination matches with one of the safe destinations in response to target data of the data storage device that is correlated with the one or more safe destinations being needed to be transmitted to the target destination;
executing a data transmission program of the data storage device and transmitting the target data to the target destination when the target destination matches with one of the safe destinations; and
notifying a user to input a password when the target destination does not match with any of the safe destinations, and transmitting the target data to the target destination when the user has input a valid password that is the same as a preset password within a predetermined time period.

2. The method according to claim 1, wherein the setting step further comprises:
presetting the password, and storing the preset password in the storage unit.

3. The method according to claim 1, further comprising:
preventing the transmission of the target data to the target destination when the user has not input the valid password within the predetermined time period.

4. The method according to claim 1, wherein each of the safe destinations is defined as an objective storage medium that is authorized to receive the predetermined data transmitted from the data storage device.

5. The method according to claim 4, wherein the objective storage medium comprises at least one terminal device and/or at least one website server having a determined website address.

6. A data storage device, comprising:
a storage unit for storing data;
at least one processor;
one or more programs stored in the storage unit and executed by the at least one processor, the one or more programs comprising:
a setting module that sets one or more safe destinations, and correlates predetermined data stored in the storage unit with the one or more safe destinations;
a determination module that determines whether a target destination matches with one of the safe destinations, when target data stored in the storage unit correlated with the one or more safe destinations is needed to be transmitted to the target destination;
an execution module that executes a data transmission program of the data storage device and transmits the target data to the target destination when the target destination matches with one of the safe destinations; and
a verification module that notifies a user to input a password to determine whether the user is authorized to transmit the target data, when the target destination does not match with any of the safe destinations;
wherein the execution module transmits the target data to the target destination when the user has input a valid password that is the same as a preset password within a predetermined time period.

7. The data storage device according to claim 6, wherein the setting module further presets the password, and stores the preset password in the storage unit.

8. The data storage device according to claim 7, wherein the execution module further prevents the transmission of the target data to the target destination when the user has not input the valid password within the predetermined time period.

9. The data storage device according to claim 6, wherein each of the safe destinations is defined as an objective storage medium that is authorized to receive the predetermined data transmitted from the data storage device.

10. The data storage device according to claim 9, wherein the objective storage medium comprises at least one terminal device and/or at least one website server having a determined website address.
